(19) United States
(12) Patent Application Publication
(10) Pub. No.: US 2026/0025476 A1
(43) Pub. Date: Jan. 22, 2026

(54) Frame Synchronization Controller, Controlling Method, Multi-Camera Device and Storage Medium

(71) Applicant: Gravity XR Electronics & Technology Co. Lid., Ningbo (CN)

(72) Inventors: Yongmeng HE, Ningbo (CN); Rui ZHANG, Ningbo (CN); Chaohao WANG, Ningbo (CN)

(21) Appl. No.: 19/342,399

(22) Filed: Sep. 26, 2025

Related U.S. Application Data
(63) Continuation-in-part of application No. PCT/CN2023/134515, filed on Nov. 27, 2023.

(30) Foreign Application Priority Data
Mar. 31, 2023 (CN) 202310340062.6

(51) Int. Cl. H04N 5/067; H04N 23/90

(52) U.S. Cl. CPC H04N 5/067; H04N 23/90

(57) ABSTRACT

The disclosure provides a frame synchronization controller, controlling method, multi-camera device, and storage medium. The frame synchronization controller is coupled to a plurality of cameras. The plurality of cameras have a plurality of shooting frame rates, polarities, pulse widths, and/or phases. The frame synchronization controller is configured to implement operations including: obtaining a frame synchronization signal; separately determining a synchronization driving signal, adapted to the shooting frame rate, the polarity, the pulse width, and/or the phase of each camera, according to the frame synchronization signal; and transmitting each synchronization driving signal to a corresponding camera, to drive the plurality of cameras to perform synchronous shooting with a plurality of frame rates, a plurality of polarities, a plurality of pulse widths, and/or a plurality of phases.

### RELATED APPLICATIONS

This case is a continuation-in-part of, and claims benefit to, International Patent Application No. PCT/CN2023/134515, filed Nov. 27, 2023, titled “Frame Synchronization Controller, Controlling Method, Multi-Camera Device and Storage Medium,” which claims priority to Chinese Patent Application No. 202310340062.6, filed Mar. 31, 2023, titled “Frame Synchronization Controller, Controlling Method, Multi-Camera Device and Storage Medium,” each of which is incorporated by reference in its entirety.

### TECHNICAL FIELD

The present application relates to the field of image processing, in particularly to a frame synchronization controller, a multi-camera device, a frame synchronization controlling method, and a non-transitory computer-readable storage medium.

### BACKGROUND

With the gradual popularization of multi-camera shooting systems, the demand for frame synchronization control between cameras in this field is also increasing. At present, there are two main frame synchronization controlling schemes which are timestamp comparison and master-slave controlling. However, in practical operation, due to the uncontrolled exposure start time of each camera, the collected images generally have the phenomenon of asynchronous acquisition time, which increases the difficulty of timestamp comparison and reduces the effect of multi-camera image fusion display. Although the master-slave frame synchronization controlling scheme can achieve synchronous triggering of a plurality of cameras, it has high requirements for the selection and reliability of the master camera. Once an abnormality occurs in the master camera, it will cause the entire multi-camera system to be unable to output images normally. Moreover, existing master-slave systems generally do not support personalized control of the master camera, making it difficult to flexibly control the start exposure time of the master camera, and unable to dynamically adjust its shooting parameter such as shooting frame rate, polarity, pulse width, phase, etc, which poses difficulties for the integration and overall optimization of multi-camera systems with external devices such as post-processing processors.

In order to overcome the above-mentioned shortcomings of existing technologies, this field urgently needs a frame synchronization controlling technology, which uses a frame synchronization controller with frame rate modulation, polarity modulation, pulse width modulation, and/or phase modulation functions to perform frame synchronization controlling for multi-camera shooting, to adapt to frame synchronization controlling between cameras of various models, and to facilitate the overall optimization of multi-camera shooting systems and their external devices.

### SUMMARY

A brief overview of one or more aspects is provided below to provide a basic understanding of these aspects. The summary is not an extensive overview of all of the aspects that are contemplated, and is not intended to identify key or decisive elements in all aspects. The sole purpose of the summary is to present some concepts of one or more aspects in a simplified form as a prelude to the more detailed description that is presented later.

In order to overcome the above-mentioned shortcomings of existing technologies, the disclosure provides a frame synchronization controller, a multi-camera device, a frame synchronization controlling method, and a non-transitory computer-readable storage medium, which can perform frame synchronization controlling of multi-camera shooting by adopting a frame synchronization controller with frame rate modulation, polarity modulation, pulse width modulation, and/or phase modulation functions to perform frame synchronization controlling for multi-camera shooting, to adapt to frame synchronization controlling between cameras of various models, and to facilitate the overall optimization of multi-camera shooting systems and their external devices.

Specifically, according to the above-mentioned frame synchronization controller provided in the first aspect of the disclosure can connects to a plurality of cameras with various shooting frame rate, polarity, pulse width and/or phase. The frame synchronization controller is configured to: obtaining a frame synchronization signal; separately determining a synchronization driving signal, adapted to the shooting frame rate, the polarity, the pulse width and/or the phase of each camera, according to the frame synchronization signal; and transmitting each synchronization driving signal to a corresponding camera, to drive the plurality of cameras to perform synchronous shooting with a plurality of shooting frame rates, a plurality of polarities, a plurality of pulse widths, and/or a plurality of phases.

Furthermore, in some embodiments of the disclosure, the plurality of cameras comprise at least one master camera. Steps of obtaining the frame synchronization signal comprises: obtaining a frame synchronization signal with a first shooting parameter through the master camera, wherein the first shooting parameter comprises at least one of a first frame rate, a first polarity, a first pulse width and/or a first phase.

Furthermore, in some embodiments of the disclosure, the plurality of cameras further comprise at least one slave camera. Steps of separately determining a synchronization driving signal, adapted to the shooting frame rate, the polarity, the pulse width and/or the phase of each camera, according to the frame synchronization signal comprise: determining a second frame rate, a second polarity, a second pulse width and a second phase of the master camera and/or the slave camera; and modulating the frame synchronization signal according to the second frame rate, the second polarity, the second pulse width and the second phase, to generate the synchronization driving signal adapted to the shooting frame rate, the polarity, the pulse width and/or the phase of the master camera and/or the slave camera.

Furthermore, in some embodiments of the disclosure, the plurality of cameras are divided into a plurality of camera groups. The plurality of cameras in each of the camera groups have same shooting frame rate, polarity, pulse width and/or phase. The plurality of cameras between different camera groups have different shooting frame rates, polarities, pulse widths and/or phases. Steps of separately determining a synchronization driving signal, adapted to the shooting frame rate, the polarity, the pulse width and/or the phase of each camera, according to the frame synchronization signal comprise: determining a shooting frame rate, a polarity, a pulse width and/or a phase that need to be modulated according to camera group which the master camera and the slave camera belong, wherein the master camera and the slave camera belong to same camera group or different camera groups; and modulating the frame synchronization signal according to the shooting frame rate, the polarity, the pulse width and/or the phase that need to be modulated, to generate a synchronization driving signal with the second shooting frame rate, the second polarity, the second pulse width and/or the second phase.

Furthermore, in some embodiments of the disclosure, the frame synchronization controller comprises at least one subsystem. Steps of obtaining the frame synchronization signal comprise: obtaining a subsystem operating signal with a third frame rate, a third polarity, a third pulse width and/or a third phase through the subsystem; and determining the frame synchronization signal according to the subsystem operating signal.

Furthermore, in some embodiments of the disclosure, the subsystem comprises a communicator. The communicator connects to an application processor of an extended reality display device. Steps of obtaining the frame synchronization signal comprise: obtaining a vertical synchronization signal with the third shooting parameter from the application processor through the communicator; and determining the frame synchronization signal according to the vertical synchronization signal.

Furthermore, in some embodiments of the disclosure, the application processor further generates a virtual image to be synthesized along with the vertical synchronization signal. The virtual image has a first distortion. A real image to be synthesized that is captured by the plurality of cameras has a second distortion. Steps of determining the frame synchronization signal according to the vertical synchronization signal comprise: obtaining a first accumulation duration of a first accumulation data amount required for correcting the virtual image, and a second accumulation duration of a second accumulation data amount required for correcting the real image, to determine a synchronization delay; and determining a triggering time of the frame synchronization signal, according to a triggering time of the vertical synchronization signal and the synchronization delay.

Furthermore, in some embodiments of the disclosure, the frame synchronization controller further comprises an internal memory, used to retrieve and cache the virtual image from the application processor at a first transmission speed, and retrieve and cache the real image from the plurality of cameras at a second transmission speed. Herein, the first accumulation duration is determined according to a ratio of the first accumulation data amount to the first transmission speed, and the second accumulation duration is determined according to a ratio of the second accumulation data amount to the second transmission speed.

Furthermore, in some embodiments of the disclosure, the frame synchronization controller further comprises a data processor. The frame synchronization controller is further configured to: in response to a trigger signal generated by the data processor at regular intervals, transmitting the virtual image of the first accumulation data amount and the real image of the second accumulation data amount, cached in the internal memory, to the data processor to perform distortion removal and image synthesis; and transferring a synthesized image obtained from the image synthesis to an external display screen to perform image display.

Furthermore, in some embodiments of the disclosure, the subsystem comprises a communicator. The communicator connects to an external display screen. Steps of obtaining the frame synchronization signal comprise: obtaining a display channel refresh signal with the third frame rate, the third polarity, the third pulse width and/or the third phase from the external display screen through the communicator; and determining the frame synchronization signal according to the display channel refresh signal.

Furthermore, in some embodiments of the disclosure, steps of separately determining a synchronization driving signal, adapted to the shooting frame rate, the polarity, the pulse width and/or the phase of each camera, according to the frame synchronization signal comprise: determining the second frame rate and the second phase of each camera, according to the third frame rate and the third phase of the display channel refresh signal; and modulate the frame synchronization signal, to generate a synchronization drive signal, adapted to the shooting frame rate, the polarity, the pulse width, and/or the phase of each camera, according to the second frame rate and the second phase.

Furthermore, in some embodiments of the disclosure, the frame synchronization controller further connects to an external display screen, and is configured to: determining a synchronization driving signal adapted to a refresh rate, a polarity, a duty cycle and/or a phase of the external display screen, according to the frame synchronization signal; and transmitting the synchronization driving signal to the external display screen, to drive the external display screen to perform synchronous displaying that is corresponding to the refresh rate, the polarity, the duty cycle and/or the phase.

Furthermore, in some embodiments of the disclosure, steps of separately determining a synchronization driving signal, adapted to the shooting frame rate, the polarity, the pulse width and/or the phase of each camera, according to the frame synchronization signal comprise: obtaining a system power consumption parameter and/or a system bandwidth load parameter of the frame synchronization controller; determining the frame rate, the polarity, the pulse width and/or the phase of each camera, according to the system power consumption parameter and/or the system bandwidth load parameter; and modulating the frame synchronization signal according to the second frame rate, the second polarity, the second pulse width and/or the second phase, to generate the synchronization driving signal adapted to the shooting frame rate, the polarity, the pulse width and/or the phase of each camera.

Furthermore, in some embodiments of the disclosure, the frame synchronization controller further comprises a bus monitor. The bus monitor connects to an extended reality display device to obtain the system power consumption parameter thereof. Steps of determining the shooting parameter of each camera, according to the system power consumption parameter comprise: in response to the system power consumption parameter reaching a preset first threshold, transmitting a frame rate reduction request to a signal generator that generates a vertical synchronization signal, to reduce a third frame rate of at least one non-real-time camera among the plurality of cameras; and in response to the system power consumption parameter decreasing to a preset second threshold, transmitting a frame rate recovery request to the signal generator to recover the third frame rate of the at least one non-real-time camera, wherein the second threshold is not greater than the first threshold.

Furthermore, in some embodiments of the disclosure, the frame synchronization controller further comprises a bus monitor. The bus monitor connects to an extended reality display device to obtain the system bandwidth load parameter thereof. Steps of determining the shooting parameter of each camera according to the system bandwidth load parameter comprise: in response to the system bandwidth load parameter reaching a preset third threshold, transmitting a frame rate reduction request to a signal generator that generates a vertical synchronization signal, to reduce a third frame rate of at least one non-real-time camera among the plurality of cameras; and in response to the system bandwidth load parameter decreasing to a preset fourth threshold, transmitting a frame rate recovery request to the signal generator to recover the third frame rate of the at least one non-real-time camera, wherein the fourth threshold is not greater than the third threshold.

In addition, according to the above-mentioned multi-camera device provided in the second aspect of the disclosure comprises a plurality of cameras and the frame synchronization controller provided in the first aspect of the disclosure. The plurality of cameras have a plurality of shooting frame rates, polarities, pulse widths and/or phases.

In addition, according to the above-mentioned frame synchronization controlling method provided in the third aspect of the disclosure comprises following steps: obtaining a frame synchronization signal; separately determining a synchronization driving signal, adapted to a shooting parameter of each camera, according to the frame synchronization signal; and transmitting each synchronization driving signal to a corresponding camera, to drive the plurality of cameras to perform synchronous shooting, according to the plurality of shooting parameters.

In addition, according to the above-mentioned non-transitory computer-readable storage medium provided in the forth aspect of the disclosure stores a computer instruction thereon. The frame synchronization controlling method provided in the third aspect of the disclosure is implemented when the computer instruction is executed by a processor.

In yet another aspect, an electronic system includes a plurality of cameras, a frame synchronization controller, and memory. The plurality of cameras have a plurality of shooting parameters, and the plurality of shooting parameters comprise at least one of a frame rate, a polarity, a pulse width, and a phase. The frame synchronization controller is coupled to the plurality of cameras. The plurality of cameras have the plurality of shooting parameters, and the plurality of shooting parameters comprise at least one of the frame rate, the polarity, the pulse width and the phase. The memory is coupled to the frame synchronization controller, and stores one or more programs configured for execution by the frame synchronization controller. The one or more programs include instructions for obtaining a frame synchronization signal, separately determining a synchronization driving signal, adapted to a shooting parameter of each camera, according to the frame synchronization signal, and transmitting each synchronization driving signal to a corresponding camera, to drive the plurality of cameras to perform synchronous shooting, according to the plurality of shooting parameters.

### BRIEF DESCRIPTION OF THE DRAWINGS

The above features and advantages of the disclosure will be better understood after reading the detailed description of the embodiments of the present disclosure in conjunction with the following figures. In the figures, components are not necessarily drawn to scale, and components having similar related features may have the same or similar reference numerals.

FIG. 1 shows an architecture of a frame synchronization controller provided according to some embodiments of the disclosure.

FIG. 2 shows a flowchart of a frame synchronization controlling method provided according to some embodiments of the disclosure.

FIG. 3A to FIG. 3C show a schematic diagram of three working modes of a frame synchronization controller provided according to some embodiments of the disclosure.

FIG. 4 shows a controlling timing diagram of a frame synchronization controller provided according to some embodiments of the disclosure.

FIG. 5 shows a schematic diagram of the architecture of a frame synchronization controller provided according to other embodiments of the disclosure.

FIG. 6 shows a controlling timing diagram of a frame synchronization controller provided according to other embodiments of the disclosure.

FIG. 7 shows a schematic diagram of obtaining a frame synchronization signal from an extended reality device according to some embodiments of the disclosure.

FIG. 8A shows a timing diagram of image synthesis display provided according to some comparative embodiments of the disclosure.

FIG. 8B shows a timing diagram of image synthesis display provided according to some embodiments of the disclosure.

FIG. 9 shows a schematic diagram of adjusting a synchronization driving signal according to a system parameter provided according to some embodiments of the disclosure.

### DETAILED DESCRIPTION OF EMBODIMENTS

The implementations of the disclosure are described below by specific embodiments. Those skilled in the art can easily understand other advantages and effects of the disclosure from the contents disclosed in the description. Although the description of the disclosure is introduced together with preferred embodiments, it does not mean that the features of the disclosure are limited to the embodiments. On the contrary, the purpose of introducing the disclosure in combination with the embodiments is to cover other options or modifications that may be extended based on the claims of the present invention. In order to provide a deep understanding of the disclosure, the following description will contain many specific details. The disclosure can also be implemented without using these details. In addition, in order to avoid confusion or ambiguity of the key points of the disclosure, some specific details is omitted in the description.

In the description of the disclosure, it should be noted that, unless otherwise specified and defined, the terms “installation”, “connecting” and “connection” should be understood in a broad sense. For example, they can be fixed connection, removable connection or integrated connection; mechanical connection or electrical connection; as well as direct connection, indirect connection through intermediate media or internal connection of two components. For those skilled in the art, the specific meaning of the above terms in the disclosure can be understood in specific cases.

In addition, the words “up”, “down”, “left”, “right”, “top”, “bottom”, “horizontal” and “vertical” used in the following description should be understood as the orientation shown in this paragraph and the relevant drawings. This relative term is only for convenience of explanation, and does not mean that the described device needs to be manufactured or operated in a specific direction, so it should not be understood as a limitation of the disclosure.

It is understood that although the terms “first”, “second”, “third”, etc. can be used here to describe various components, regions, layers and/or parts, these components, regions, layers and/or parts should not be limited by these terms, and these terms are only used to distinguish different components, regions, layers and/or parts. Therefore, a first component, area, layer and/or part discussed below can be referred to as a second component, area, layer and/or part without departing from some embodiments of the disclosure.

As mentioned above, there are two main frame synchronization controlling schemes which are timestamp comparison and master-slave controlling at present. However, in practical operation, due to the uncontrolled exposure start time of each camera, the collected images generally have the phenomenon of asynchronous acquisition time, which increases the difficulty of timestamp comparison and reduces the effect of multi-camera image fusion display. Although the master-slave frame synchronization controlling scheme can achieve synchronous triggering of a plurality of cameras, it has high requirements for the selection and reliability of the master camera. Once an abnormality occurs in the master camera, it will cause the entire multi-camera system to be unable to output images normally. Moreover, existing master-slave systems generally do not support personalized control of the master camera, making it difficult to flexibly control the start exposure time of the master camera, and unable to dynamically adjust its shooting parameter such as frame rate, polarity, pulse width, phase, etc. This poses difficulties for the integration and overall optimization of multi-camera systems with external devices such as post-processing units.

In order to overcome the above-mentioned shortcomings of existing technologies, the disclosure provides a frame synchronization controller, a multi-camera device, a frame synchronization controlling method, and a non-transitory computer-readable storage medium, which can perform frame synchronization controlling of multi-camera shooting by adopting a frame synchronization controller with frame rate modulation, polarity modulation, pulse width modulation, and/or phase modulation functions to perform frame synchronization controlling for multi-camera shooting, to adapt to frame synchronization controlling between cameras of various models, and to facilitate the overall optimization of multi-camera shooting systems and their external devices.

In some non-limiting embodiments, the above-mentioned frame synchronization controlling method provided in the third aspect of the disclosure can be implemented by the above-mentioned frame synchronization controller provided in the first aspect of the disclosure. Specifically, the frame synchronization controller can be configured in the multi-camera device provided in the second aspect of the disclosure, wherein it is configured with a memory and a processor. The memory includes, but is not limited to, the above-mentioned computer-readable storage medium provided in the forth aspect of the disclosure, on which computer instructions are stored. The processor is connected to the memory and configured to execute the computer instructions stored on the memory to implement the above-mentioned frame synchronization controlling method provided in the third aspect of the disclosure.

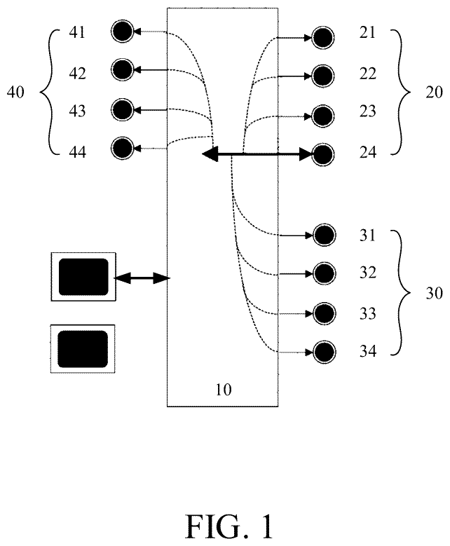

Firstly, please refer to FIG. 1. FIG. 1 shows an architecture of a frame synchronization controller provided according to some embodiments of the disclosure.

As shown in FIG. 1, in some embodiments of the disclosure, the frame synchronization controller 10 can be integrated into the control chip of a multi-camera device in the form of a hardware module, connecting to a plurality of cameras 21 to 24, 31 to 34, 41 to 44 of the multi-camera device to reduce the overall delay of the chip and provide synchronized images for algorithms such as StereoDepth, SLAM, hand tracking, eye tracking based on multi-camera architecture. Herein, the multi-camera device include but are not limited to mobile phone, security system, drone, autonomous vehicle, AR/VR/MR, robot and other electronic device that capture images through the plurality of cameras. The plurality of cameras 21 to 24, 31 to 34, 41 to 44 can have a plurality of different shooting frame rates, positive/negative trigger polarities, pulse widths, and/or phases, and cooperate with each other to capture images, thereby obtaining the highest quality captured images at the lowest software and hardware costs.

The working principle of the above frame synchronization controller and the multi-camera device will be described below in conjunction with some embodiments of some frame synchronization controlling methods. Those skilled in the art can understand that the embodiments of these frame synchronization controlling methods only provide some non-limiting implementations of the disclosure, which is intended to clearly display the main idea of the disclosure, and provide some specific proposals that are convenient for the public to implement, rather than limiting all working modes or all functions of the frame synchronization controller and the multi-camera device. Similarly, the frame synchronization controller and the multi-camera device is only a non-limiting embodiment provided by the disclosure, and does not limit the implementation subject to each step in these frame synchronization controlling.

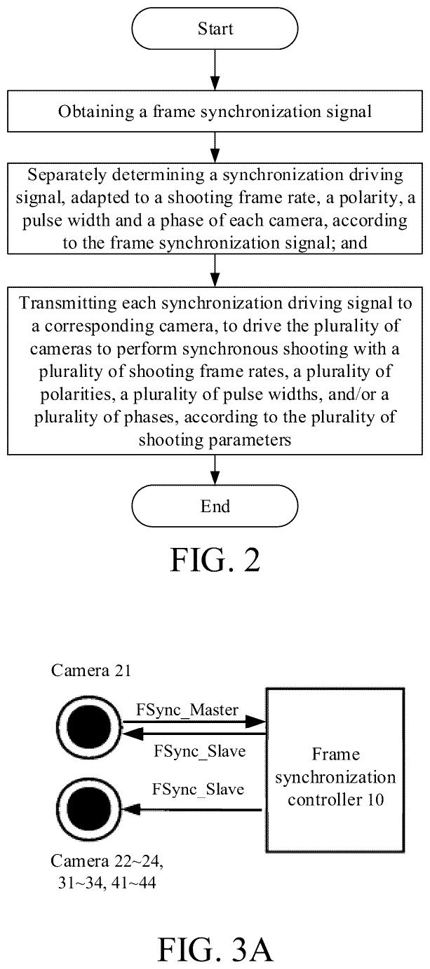

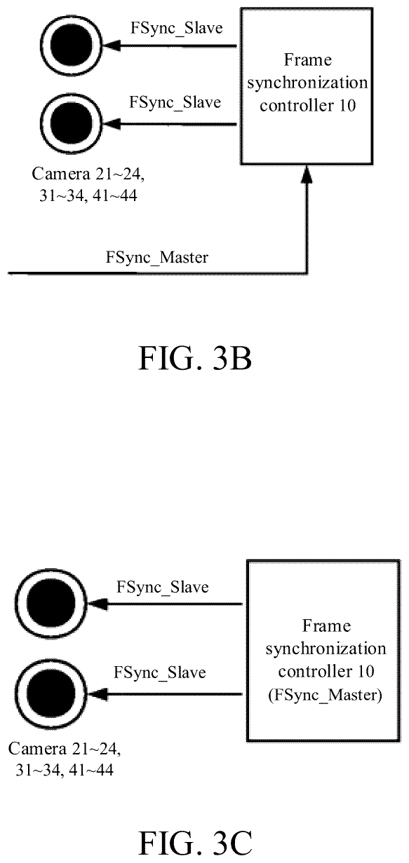

Please refer to FIG. 2 and FIG. 3A to FIG. 3C. FIG. 2 shows a flowchart of a frame synchronization controlling method provided according to some embodiments of the disclosure. FIG. 3A to FIG. 3C show a schematic diagram of three working modes of a frame synchronization controller provided according to some embodiments of the disclosure.

As shown in FIG. 2, during the process of frame synchronization controlling, the frame synchronization controller 10 can firstly obtain a frame synchronization signal, and separately determine a synchronization driving signal, adapted to the a shooting frame rate, a positive/negative trigger polarity, a pulse width, and/or a phase of each camera 21 to 24, 31 to 34, 41 to 44 according to the obtained frame synchronization signal. Then, transmit each synchronization driving signal to the corresponding cameras 21 to 24, 31 to 34, 41 to 44, to drive the plurality of cameras 21 to 24, 31 to 34, 41 to 44 to cooperate with each other to perform synchronous shooting with a plurality of frame rates, a plurality of polarities, a plurality of pulse widths, and/or a plurality of phases synchronization shooting.

In some embodiments, the frame synchronization controller 10 can have a plurality of operating modes as shown in FIG. 3A to FIG. 3C. Taking the multi-camera device with at least one master camera 21 as shown in FIG. 1 as an example, the frame synchronization controller 10 can obtain a frame synchronization signal FSync_Master with a first frame rate (e.g. 120 fps), a first polarity, a first pulse width, and/or a first phase through the master camera 21 as shown in FIG. 3A, and separately determine the camera parameters of the master camera 21 and/or the each slave cameras 22 to 24, 31 to 34, 41 to 44 by retrieving locally pre-stored data and engaging in real-time data interaction with the other slave cameras 22 to 24, 31 to 34, 41 to 44. Afterwards, the frame synchronization controller 10 can independently and dynamically determine a second frame rate, a second polarity, a second pulse width, and/or a second phase required for synchronous shooting of each camera 21 to 24, 31 to 34, 41 to 44, according to an actual shooting resolution requirement and/or real-time system state data such as the power consumption parameter and bandwidth load parameter of the multi-camera device, and modulate the frame synchronization signal FSync_Master in frame rate, polarity, pulse width, and/or phase to generate a synchronization driving signal FSync_Slave, adapted to the second shooting frame rate, the second polarity, the second pulse width, and/or the second phase of each camera according to this. Afterwards, the frame synchronization controller 10 can transmit each synchronization driving signal FSync_Slave to the corresponding cameras 21 to 24, 31 to 34, 41 to 44, respectively, to drive the plurality of cameras 21 to 24, 31 to 34, 41 to 44 to perform synchronous shooting with a plurality of frame rates, a plurality of polarities, a plurality of pulse widths, and/or a plurality of phases.

Furthermore, in some preferred embodiments, the plurality of cameras 21 to 24, 31 to 34, 41 to 44 in the multi-camera device can be divided into a plurality of camera groups 20, 30, 40 according to the shooting parameter such as model, resolution, and frame rate. The plurality of cameras (e.g. cameras 21 to 24) in same camera group 20 have the same shooting frame rate, polarity, pulse width, and/or phase, while the plurality of cameras (e.g. cameras 21, 31, 41) between different camera groups 20, 30, and 40 can involve different shooting frame rates, polarities, pulse widths, and/or phases. In this way, in the process of determining the synchronization driving signal FSync_Slave, adapted to the second shooting frame rate, the second polarity, the second pulse width, and/or the second phase of each camera according to the frame synchronization signal FSync_Master, the frame synchronization controller 10 can preferably determine the shooting frame rate, the polarity, the pulse width, and/or the phase that needs to be modulated according to the camera group which the master camera 21 and the slave cameras 22 to 24, 31 to 34, 41 to 44 belong, and efficiently obtain the required synchronization driving signal FSync_Slave by modulating the frame synchronization signal FSync_Master according to the required shooting frame rate, the polarity, the pulse width, and/or the phase.

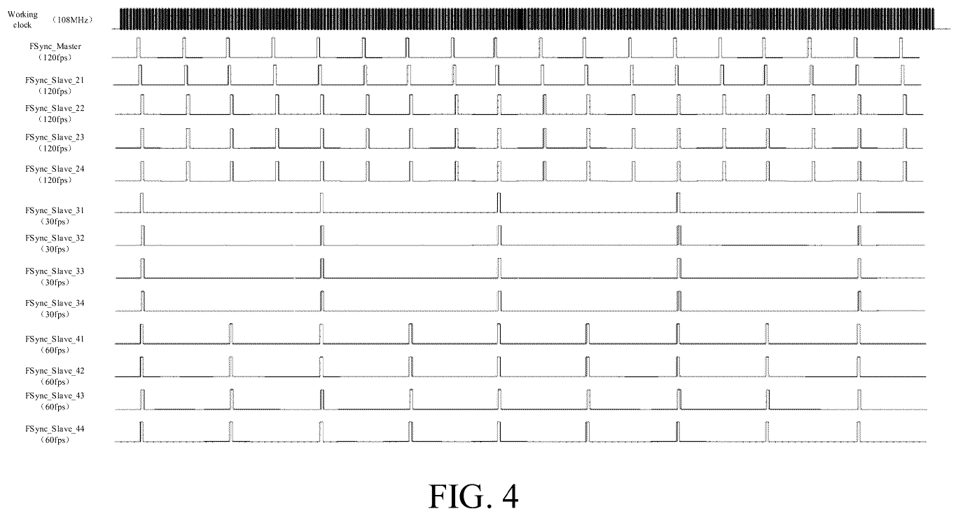

Please refer to FIG. 4 for details. FIG. 4 shows a controlling timing diagram of a frame synchronization controller provided according to some embodiments of the disclosure.

As shown in FIG. 4, for the slave camera 22 belonging to the same camera group as the master camera 21, the frame synchronization controller 10 can determine that the slave camera 22 and the master camera 21 have the same shooting frame rate, polarity, and pulse width, and have different phases according to the grouping rules of the camera groups, thereby performing targeted phase modulation of the frame synchronization signal FSync_Slave_22, to efficiently obtain the required synchronization driving signal FSync_Slave_22 for the slave camera 22.

For example, for the slave camera 31 belonging to a different camera group from the master camera 21, the frame synchronization controller 10 can determine that the slave camera 31 and the master camera 21 have the same polarity, pulse width, and phase, according to the grouping rules of the camera groups, and have different shooting frame rates, to selectively modulate the frequency of the frame synchronization signal FSync_Master to efficiently obtain the synchronization driving signal FSync_Slave_31 required by the slave camera 31.

Similarly, the frame synchronization controller 10 can also determine the synchronization driving signals FSync_Slave_i of the remaining cameras i one by one as described above, which will not be described here one by one. In this way, in a large multi-camera device composed of a large number of cameras, the present invention can selectively modulate a few different shooting parameters according to the grouping rules between each camera, thereby reducing the computational load of the frame synchronization controller 10.

In summary, compared to traditional master-slave control schemes, the present invention can flexibly modulate the frame synchronization signal FSync_Master according to camera parameter such as resolution and trigger polarity of each slave camera 22 to 24, 31 to 34, 41 to 44, to meet the synchronization driving requirements of various models of cameras and the adaptation requirements of various types of peripherals. On the other hand, it can return the synchronization driving signal FSync_Slave generated by the frame synchronization controller 10 to the master camera 21 and control the master camera 21 to perform frame synchronous shooting according to the synchronization driving signal FSync_Slave, thereby flexibly and accurately controlling the start exposure time of the camera 21 for subsequent fusion processing of a plurality of frame synchronization images.

Furthermore, by incorporating real-time system state data such as actual shooting resolution requirements, the system power consumption parameter and the system bandwidth load parameter of the multi-camera device to participate in the decision making of the synchronization driving signal FSync_Slave, the present invention can also achieve multi-dimensional overall optimization of shooting effect, power consumption, bandwidth, etc. of the entire multi-camera device within the chip, which is more conducive to the application in special scenarios involving high resolution and high frame rate shooting and/or display requirements such as unmanned aerial vehicle, autonomous driving vehicle, AR/VR/MR, robot and so on.

Those skilled in the art can understand that the embodiment shown in FIG. 3A, which obtains the frame synchronization signal FSync_Master through the master camera 21, is only a non-limiting embodiment provided by the disclosure, aiming to clearly demonstrate the main idea of the disclosure and provide a specific solution that is convenient for the public to implement, rather than limiting the scope of protection of the present invention.

Optionally, in other embodiments, the frame synchronization controller 10 can further be configured with at least one subsystem. The frame synchronization controller 10 can also obtain a subsystem operating signal with a third frame rate, a third polarity, a third pulse width, and/or a third phase through the at least one subsystem, and determine the frame synchronization signal FSync_Slave that drives each camera 21 to 24, 31 to 34, 41 to 44 according to the subsystem operating signal.

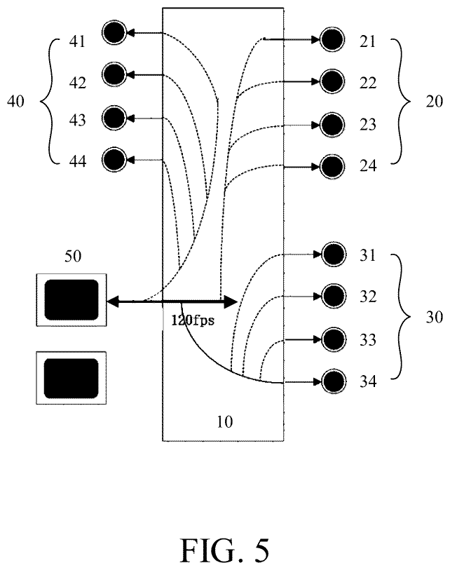

Please refer to FIG. 3B and FIG. 5. FIG. 5 shows a schematic diagram of the architecture of a frame synchronization controller provided according to other embodiments of the disclosure.

As shown in FIG. 3B and FIG. 5, the frame synchronization controller 10 can preferably be configured with a communication subsystem, and connected to an external display screen 50 via the communication subsystem. In the process of obtaining the frame synchronization signal FSync_Master, the frame synchronization controller 10 can firstly obtain a display channel refresh signal with the third frame rate (e.g. 120 fps), the third polarity, the third pulse width, and/or the third phase from the display screen 50 through the communication subsystem, and determine the frame synchronization signal FSync_Master according to the display channel refresh signal. Herein, the frame synchronization controller 10 can directly use the display channel refresh signal as the frame synchronization signal FSync_Master according to preset settings, or it can firstly modulate the frame rate, the polarity, the pulse width, and/or the phase of the display channel refresh signal, and then use the modulation signal as the frame synchronization signal FSync_Master, wherein the specific modulation method is not limited here.

Afterwards, the frame synchronization controller 10 can independently and dynamically determine the second frame rate, the second polarity, the second pulse width, and/or the second phase required for performing synchronous shooting of each camera 21 to 24, 31 to 34, 41 to 44 by retrieving local pre-stored data, real time data interaction with the slave cameras 21 to 24, 31 to 34, 41 to 44, and other methods as described above. Then independently and dynamically determine the second frame rate, the second polarity, the second pulse width, and/or the second phase of each camera 21 to 24, 31 to 34, 41 to 44 required for performing synchronous shooting according to the actual shooting resolution requirements and/or real time system state data such as the power consumption parameter and the bandwidth load parameter of the multi-camera device, and modulates the frame rate, the polarity, the pulse width, and/or the phase of the frame synchronization signal FSync_Master to generate a synchronization driving signal FSync_Slave, adapted to the second shooting frame rate, the second polarity, the second pulse width, and/or the second phase of each camera. Afterwards, the frame synchronization controller 10 can transmit the each synchronization driving signal FSync_Slave to the corresponding cameras 21 to 24, 31 to 34, 41 to 44, respectively, to drive the plurality of cameras 21 to 24, 31 to 34, 41 to 44 to perform synchronous shooting with a plurality of frame rates, a plurality of polarities, a plurality of pulse widths, and/or a plurality of phases.

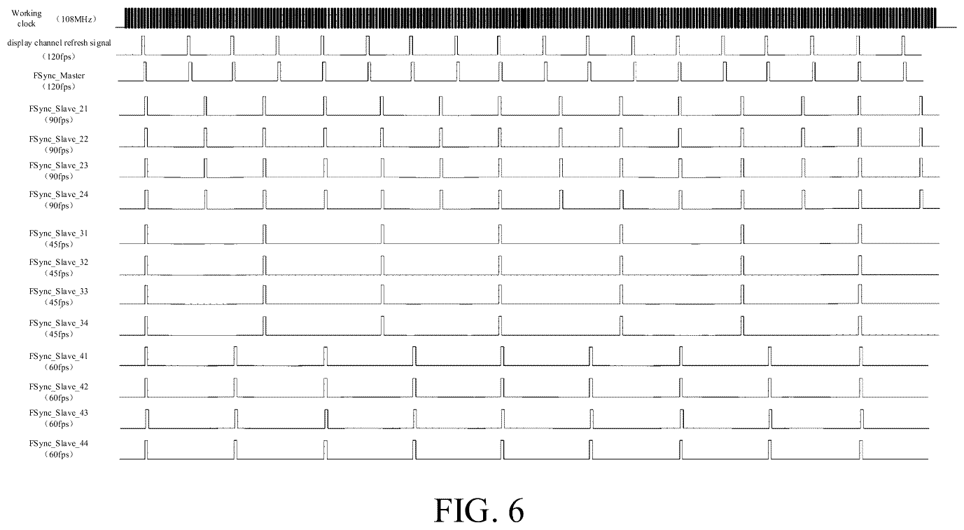

Please refer to FIG. 6 for details. FIG. 6 shows a controlling timing diagram of a frame synchronization controller provided according to other embodiments of the disclosure.

As shown in FIG. 6, taking the camera 21 as an example, in the process of generating the synchronization driving signal FSync_Slave_21, adapted to camera 21, the frame synchronization controller 10 can firstly determine the camera parameter of the camera 21 by retrieving locally pre-stored data, real time data interaction with the camera 21, etc. Then dynamically determine the second frame rate, the second polarity, the second pulse width, and/or the second phase required for performing synchronous shooting of the camera 21 according to the actual shooting resolution requirements and/or real time system state data such as the power consumption parameter and the bandwidth load parameter of the multi-camera device, and modulate the frame rate, the polarity, the pulse width, and/or the phase of the frame synchronization signal FSync_Master according to this, to generate a synchronization driving signal FSync_Slave_21, adapted to the second shooting frame rate, the second polarity, the second pulse width, and/or the second phase of the camera 21.

Similarly, the frame synchronization controller 10 can also determine the synchronization driving signals FSync_Slave_i of the remaining cameras i one by one as described above, which will not be described here one by one.

Furthermore, in some embodiments, the frame synchronization controller 10 can also preferably determine the second shooting frame rate and the second phase of the camera 21 according to the third frame rate and the third phase of the display channel refresh signal, to make a display timing of the display channel refresh signal as close as possible to the exposure timing of the camera 21. In this way, the present invention can further compress the time difference from the exposure time point of the camera 21 to the corresponding information appearing on the display screen 50, in order to improve the real time performance of multi-camera fusion image display.

Those skilled in the art can understand that the above scheme of connecting the communication subsystem to the external display screen 50 to drive the cameras 21 to 24, 31 to 34, 41 to 44 to perform synchronous shooting according to the display channel refresh signal of the display screen 50 is only a non-limiting embodiment provided by the disclosure, aiming to clearly demonstrate the main concept of the disclosure and provide a specific solution for public implementation, rather than limiting the scope of protection of the disclosure.

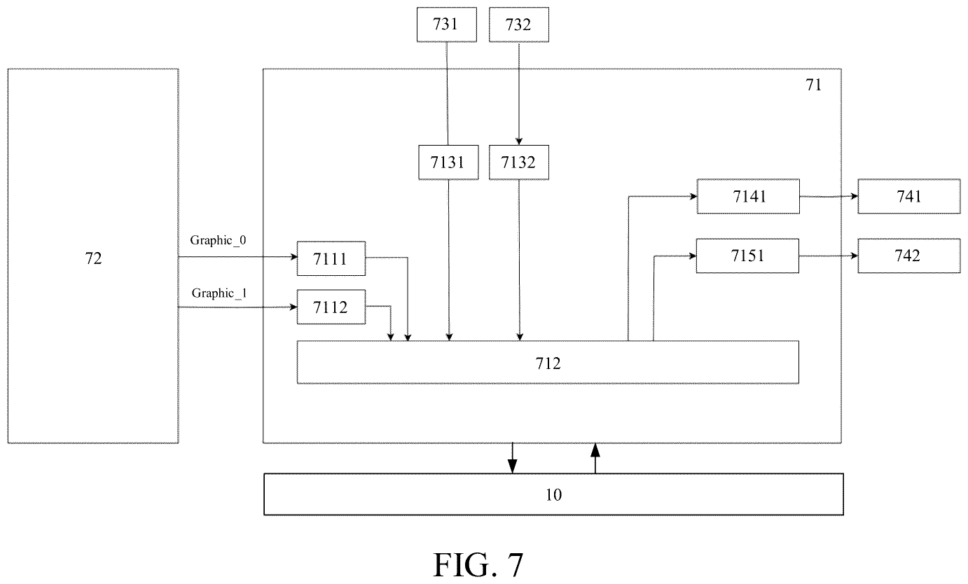

Optionally, please refer to FIG. 7. FIG. 7 shows a schematic diagram of obtaining a frame synchronization signal from an extended reality (XR) device according to some embodiments of the disclosure. In the embodiment shown as FIG. 7, the communication subsystem of the frame synchronization controller 10 can also be connected to the coprocessor 71 of the extended reality display device, and then connected to its application processor 72 through the coprocessor 71.

In some embodiments, the application processor 72 can be separately integrated into the application system on chip (AP SoC) of the extended reality display device, while the coprocessor 71 can be integrated with the frame synchronization controller 10 into the mixed reality system on chip (MR SoC) of the extended reality display device.

Optionally, in other embodiments, the coprocessor 71, the application processor 72, and the frame synchronization controller 10 can be integrated together into the same on-chip system and connected to each other through on-chip communication.

Optionally, in other embodiments, the frame synchronization controller 10 can be independently and detachably configured, and connected to the coprocessor 71 through inter-board communication.

During the process of performing extended reality image display, the application processor 72 can render and generate virtual images Graphic_0 and Graphic_1 according to a vertical synchronization signal HW FSync Out provided by a signal generation unit (e.g. HW Frame Sync engine), and transfer each virtual image Graphic_0 and Graphic_1 to an internal memory 712 of the coprocessor 71 for caching via image high-speed interfaces 7111 to 7112 of the coprocessor 71. Herein, the high-speed interfaces 7111 to 7112 for the image can be configured with Display Rx ports, which are equipped with DP Rx or MIPI DSI Rx high-speed interfaces and corresponding DP/DSI protocol parsers. The image high-speed interfaces 7111 to 7112 cache the virtual images Graphic_0 and Graphic_1 obtained from the application processor 72 to the internal memory 712 at a first transmission speed.

At the same time, the frame synchronization controller 10 obtains the vertical synchronization signal HW FSync Out from the application processor 72 through its communication subsystem and the image high-speed interfaces 7111 to 7112 of the coprocessor 71, and determines the corresponding frame synchronization signal FSync_Master according to the vertical synchronization signal HW FSync Out (for example, determining the corresponding frame synchronization signal FSync_Master according to a specified multiple of the vertical synchronization signal HW FSync Out). Herein, the vertical synchronization signal HW FSync Out has a third shooting parameter, including but not limited to at least one of a third frame rate, a third polarity, a third pulse width, and a third phase. Afterwards, the frame synchronization controller 10 can determine the synchronization driving signal FSync_Slave, adapted to the shooting parameter of each camera 731 to 732 according to the minimum common multiple of the shooting frame rates of each camera 731 to 732 and the frame synchronization signal FSync_Master, and then separately transmit it to the corresponding cameras 731 to 732 to drive them to perform synchronous shooting of the corresponding shooting parameter. Afterwards, the each camera 731 to 732 can transmit the captured real image data to the corresponding image signal processing (ISP) pipeline 7131 to 7132 of the coprocessor 71. The ISP pipeline 7131 to 7132 is used to convert the captured real image data into human visual habits and cache it in the internal memory 712 of the coprocessor 71 at a second transmission speed.

In some embodiments, the application processor 71 renders and generates virtual images Graphic_0 and Graphic_1, which may have a first distortion (such as a optical distortion), while a real image captured by the cameras 731 to 732 can have a different second distortion (such as a camera distortion) due to the differences between the cameras 731 to 732. In order to correct the distortions and improve the display effect of the synthesized image, data processing units 7141 to 7142 configured in the coprocessor 71 can firstly perform distortion removal on the virtual images Graphic_0, Graphic_1, and the real image cached in the internal memory 712, and then perform image synthesis on the distorted virtual images Graphic_0, Graphic_1, and the real image.

Furthermore, considering that the amount of startup data required for distortion removal processing of different types of distortion varies, the display processing units (DPUs) 7141 to 7142 can generate a trigger signal DPU VSYNC, in response to the virtual images Graphic_0 and Graphic_1 cached in the internal memory 712 reaching a corresponding first accumulation data amount (e.g. ⅓ frame), and the data amount of the real image cached in the internal memory 712 reaching a corresponding second accumulation data amount (e.g. ⅙ frame), to initiate the distortion removal processing of the virtual images Graphic_0, Graphic_1, and the real image.

Furthermore, technicians can determine a first accumulation duration, according to the ratio of the first accumulation data amount to the first transmission speed, and determine a second accumulation duration, according to the ratio of the second accumulation data amount to the second transmission speed, then determine a synchronization delay ΔT, according to the difference between the two. Afterwards, the frame synchronization controller 10 can determine a triggering time T₂=T₁+ΔT of the frame synchronization signal FSync_Master according to the triggering time T₁ of the vertical synchronization signal HW FSync Out and the synchronization delay ΔT, then determine the synchronization driving signal FSync_Slave, adapted to the shooting parameter of each camera 731 to 732 according to the frame synchronization signal FSync_Master, to drive the corresponding cameras 731 to 732 to perform synchronous shooting according to the shooting parameter.

Afterwards, the data processing units 7141 to 7142 can generate a trigger signal DPU VSYNC as described above to initiate the distortion removal and image synthesis of the virtual images Graphic_0, Graphic_1, and the real image. Then, transmit the synthesized image obtained from the image synthesis to the external display screens 741 to 742 to perform image display.

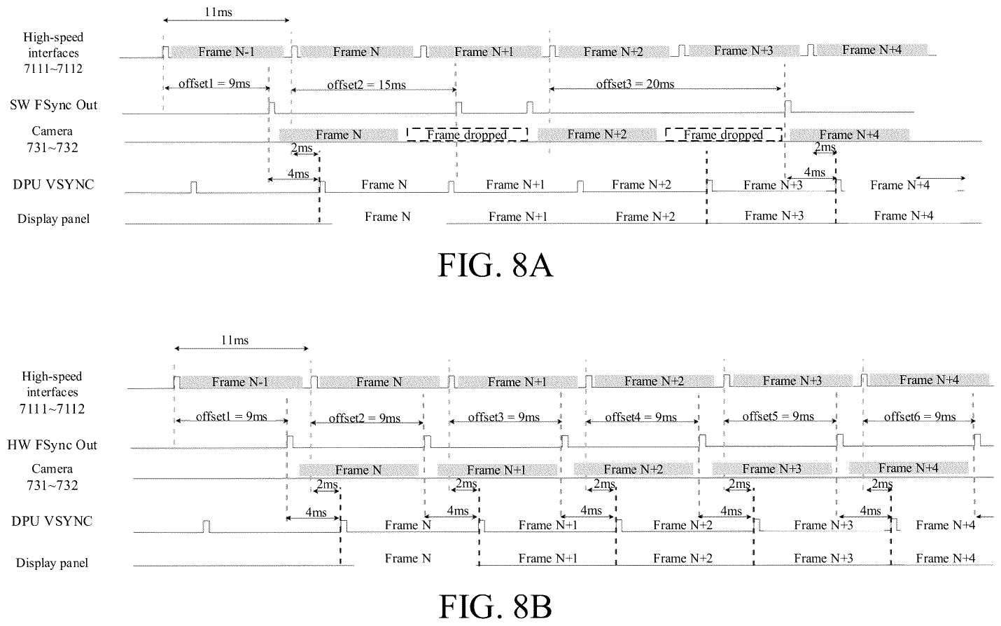

Furthermore, please compare and refer to FIG. 8A and FIG. 8B. FIG. 8A shows a timing diagram of image synthesis display provided according to some comparative embodiments of the disclosure. FIG. 8B shows a timing diagram of image synthesis display provided according to some embodiments of the disclosure.

In the comparative embodiments shown as FIG. 8A, the image high-speed interfaces 7111 to 7112 (e.g. Display Rx) receive the virtual image from the application processor 71 with a frame period of 11 ms. The extended reality display device responds to the previous Display Rx signal of the virtual image through its central processing unit (CPU) and interrupts it, and outputs a pulse synchronization signal SW FSync Out after a certain bias time T_{offset}, as the frame synchronization signal for driving each camera 731 to 732. The calculation method for the offset time T_{offset} is as follows:

$${T}_{offset} = {T}_{{display}_{-} isr} + {T}_{{os}_{-} schedule 1} + {T}_{{timer}_{-} cfg} + {T}_{{timer}_{-} isr} + {T}_{{os}_{-} schedule 2} + {T}_{{FSync}_{-} cfg} ,$$

where T_{display_isr} is an additional time consumed by the CPU in response to interrupts caused by the Display RX signal, which mainly depends on the hardware architecture of the CPU and generally lasts for several hundred CPU execution cycles, and T_{os_schedule1} is a time consumed by an operating system (OS) to interrupt a business processing thread in response to the Display Rx signal, from blocking to executing. It is subject to uncontrollable drift ranging from microseconds to tens of milliseconds due to system busyness, such as multi-threaded concurrency, especially when there are many high priority threads in a ready state; T_{timer_efg} is a time of a thread processing the interrupt event corresponding to the Display Rx signal, which mainly depends on a duration of the CPU configured timer; T_{timer_isr} is similar to T_{display_isr}, which is an additional time consumed by the CPU in response to timer interrupts; T_{os_schedule2} is similar to T_{os_schedule1}, which is a time consumed by scheduling the thread that actually outputs the pulse synchronization signal SW FSync Out. It also has a drift of microseconds to tens of milliseconds; T_{FSync_cfg} is a time consumed by the corresponding thread during the action of setting the high and low levels of the General Purpose Input/Output (GPIO) port for executing frame synchronization.

As shown in FIG. 8A, since the CPU of the extended reality display device needs to undertake a large number of concurrent other task threads such as image rendering and synthesis, there will inevitably be some millisecond level jitter delays, thereby causing frame dropping of the real image.

Relatively, in the comparative embodiments shown as FIG. 8B, by introducing a dedicated frame synchronization controller 10 and integrating it into the mixed reality display system on chip (MR SoC) of the extended reality display device, the Display Rx signal is received through on-chip communication, and then converted into the frame synchronization signal HW FSync Out that drives the external cameras 731 to 732. The present invention can effectively avoid the time bias and drift of T_{os_schedule1} and T_{os_schedule2} mentioned above, thereby controlling the synchronization control accuracy of the virtual image rendering and the real image acquisition within 1 us, and enabling when the data processing units 7141 to 7142 perform correction and superposition of virtual image layers and real image layers, each layer meeting the data amount threshold for initiating processing (e.g. ⅙ frame length and ⅓ frame length mentioned above). Afterwards, the data processing units 7141 to 7142 can send the processed synthesized image data to the external display screens 741 to 742 for display in rows. In some embodiments, this part of the processing can be fully implemented by hardware pipelines, thereby reducing its latency to the row level and eliminating all stage delays under the SW FSync Out scheme.

As shown in FIG. 8B, in the process of performing synchronously capture and synthesizing on the virtual image and the real image based on the frame synchronization controller 10 provided by the disclosure, the image high-speed interfaces 7111 to 7112 (e.g. Display Rx) receive the virtual image from the application processor 71 with a frame period of 11 ms. Before receiving each frame of the virtual image, the frame synchronization controller 10 obtains the Display Rx signal from the virtual image layer, and accurately generates the HW FSync Out signal according to the set bias time (e.g. T_{offset}=9 ms) to trigger the external cameras 731 to 732 to collect images. After receiving the HW FSync Out signal, the cameras 731 to 732 start the image acquisition process, which is stable in time and always aligns with each image frame. The data processing units (DPUs) 7141 to 7142 trigger VSYNC signals for each frame, and after a preset cumulative duration (e.g. 4 ms), begin to perform line by line correction and synthesis on the virtual image and the real image to generate the synthesized image corresponding to the display frame. Herein, as the dedicated frame synchronization controller 10 does not require multi-threaded concurrent load calculations, its time accuracy for generating HW FSync Out signals can reach 1 μs. The frame synchronization controller 10 can ensure that the virtual image and the real image are perfectly aligned in the layer fusion windows of the data processing units (DPUs) 7141 to 7142, and meet the accumulation data amount requirements of a first row of image data in each layer of the overlay window, thereby avoiding layer misalignment, delay, and flicker problems.

Afterwards, the data processing units (DPUs) 7141 to 7142 can synthesize and process the synthesized image data in rows, and stably output it to the external display screens 741 to 742 for image display.

By firstly determining the synchronization delay 47 according to the difference in accumulated data required to initiate distortion removal processing, and then adjusting the timing of each camera 731 to 732 capturing the real image according to this, the present invention can effectively reduce the light to light (P2P) delay and motion to light (M2P) delay of the extended reality display device, thereby minimizing the dizziness of the user and improving the experience of the user to the greatest extent possible.

In addition, in some embodiments, the frame synchronization controller 10 provided by the disclosure can also adjust the shooting parameter of each camera according to the system power consumption parameter and/or the system bandwidth load parameter of the multi-camera device or the extended display device, and then drive each camera to perform synchronous shooting of the plurality of the shooting parameter according to this.

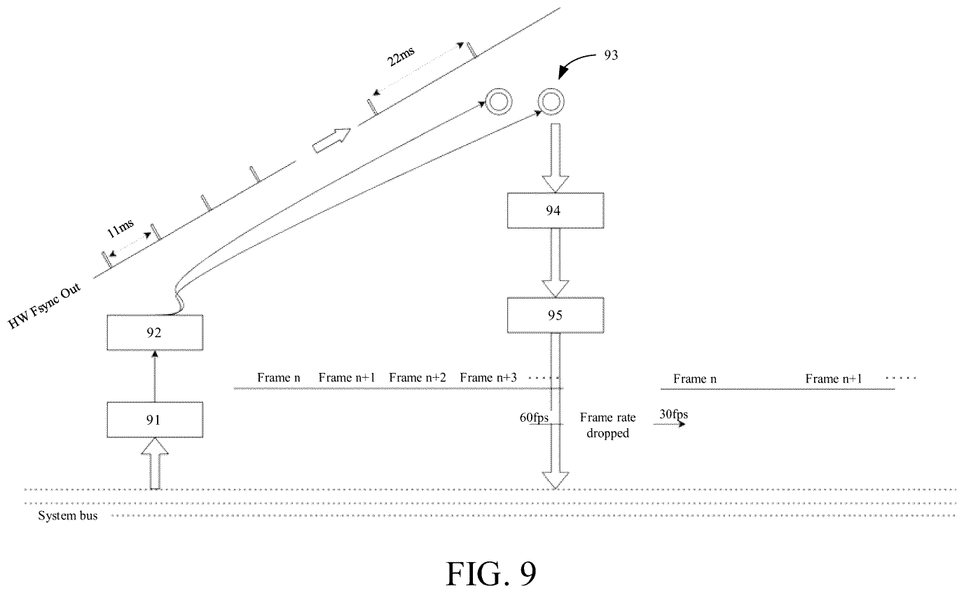

Please refer to FIG. 9 for details. FIG. 9 shows a schematic diagram of adjusting a synchronization driving signal according to a system parameter provided by some embodiments of the disclosure.

In the embodiment shown as FIG. 9, the frame synchronization controller 10 further comprises a bus monitor 91. The bus monitor 91 is connected to the system bus of the extended reality display device to monitor its system power consumption parameter. In response to the bus monitor 91 monitoring that the system power consumption has reached a preset upper limit (e.g. first threshold), it can send a frame rate reduction request to the signal generation unit 92 that generates the vertical synchronization signal HW Frame Sync to reduce the third frame rate of at least one non-real time camera 93 among the plurality of cameras mentioned above. Herein, the signal generation unit 92 can be the HW Frame Sync engine, which can be set in the application processor of the extended reality display device, or integrated as a subsystem in the frame synchronization controller 10. The non-real time camera 93 includes but is not limited to SLAM cameras, video conferencing cameras, and other cameras that do not significantly affect the fusion quality of the virtual image and the real image even if the frame rate is reduced or dropped.

Afterwards, when each camera completes the acquisition of corresponding images according to the vertical synchronization signal HW Frame Sync (i.e. a synchronization driving signal FSync_Slave) provided by a signal generation unit 92, it can transmit the collected image data to a corresponding image signal processing (ISP) pipeline 95 of the extended reality display device through the channel state information receiver (CSI Rx) 94. The ISP pipeline 95 processes it into human visual habits image data and transmits it to the system bus for subsequent internal caching and processing.

By increasing the shooting interval time of the at least one non-real time camera 93 to reduce the third frame rate of its captured images, the present invention can enable the non-real time camera 93 to avoid power peaks in the system, thereby stabilizing the instantaneous power consumption of the extended display device system at the rated balance point for a long time without seriously sacrificing image quality.

Afterwards, in response to the bus monitor 91 monitoring that the system power consumption has decreased to a preset lower limit (e.g. a second threshold), it can also send a frame rate recovery request to the signal generation unit 92 to timely restore the third frame rate of the at least one non-real time camera 93, thereby achieving a better user experience.

In addition, in other embodiments, the bus monitor 91 can also monitor the system bandwidth load parameter of the extended display device. In response to the bus monitor 91 monitoring that the system bandwidth load has reached a preset upper limit (e.g. third threshold), it can send a frame rate reduction request to the signal generation unit 92 that generates the vertical synchronization signal HW Frame Sync to reduce the third frame rate of the at least one non-real time camera 93 among the plurality of cameras mentioned above. By increasing the shooting interval time of at least one non-real time camera 93 to reduce the third frame rate of its captured images, the present invention can enable the non-real time camera 93 to avoid the peak bandwidth load of the system, thereby ensuring that the system bandwidth of the extended display device remains stable at the rated balance point for a long time without seriously sacrificing image quality.

Afterwards, in response to the bus monitor 91 monitoring that the system bandwidth load has decreased to a preset lower limit (e.g. the fourth threshold), it can also send a frame rate recovery request to the signal generation unit 92 to timely restore the third frame rate of the at least one non-real time camera 93, thereby achieving a better user experience.

In addition, please continue to refer to FIG. 3C. In other embodiments shown as FIG. 3C, for the frame synchronization controller 10 with a clock signal, it can also generate a reference frame synchronization signal internally (the frame rate is the least common multiple of the shooting frame rates of each camera), and use it as the frame synchronization signal FSync_Master to generate a synchronization driving signal FSync_Slave, adapted to the shooting frame rate, the polarity, the pulse width, and/or the phase of each camera 21 to 24, 31 to 34, 41 to 44, to drive each camera 21 to 24, 31 to 34, 41 to 44 to perform a plurality of shooting frame rates, a plurality of polarities, a plurality of pulse widths, and/or a plurality of phases synchronized shooting. The specific principle is similar to the above embodiments, which will not be described here.

Furthermore, in the embodiment shown as FIG. 5, the frame synchronization controller 10 can also transmit the internally generated Frame sync signal to the display screen 50, thereby controlling the display screen 50 to perform synchronous display with the plurality of the cameras 21 to 24, 31 to 34, 41 to 44. Specifically, the frame synchronization controller 10 can firstly determine the synchronization driving signal FSync_Slave, adapted to refresh frequency, the polarity, duty cycle, and/or phase of the display screen 50 according to the internally generated frame synchronization signal FSync_Master, and then transmit the synchronization driving signal FSync_Slave to the display screen 50 through the aforementioned communication subsystem to drive it to perform synchronous display corresponding to the refresh frequency, the polarity, the duty cycle, and/or the phase. In this way, the present invention can further compress the time difference from the exposure time point of camera 21 to the corresponding information appearing on the display screen 50, in order to improve the real-time performance of multi-camera fusion image display.

In summary, compared to the traditional master-slave control scheme, the present invention further uses external signals such as the display channel refresh signal of the display screen 50 as the frame synchronization signal FSync_Master. On one hand, it can reduce or even get rid of the dependence on the master camera, thereby improving the frame synchronization signal FSync_Master, and ensure the reliability of the source and reduce the device cost of the multi-camera device. On the other hand, it can achieve joint control with external devices such as the the display screen 50, according to the actual display requirements of the display screen 50, the cameras 21 to 24, 31 to 34, and 41 to 44 can be controlled for the frame synchronization shooting, or the display screen 50 can be controlled for performing synchronous display according to the actual shooting parameter of the cameras 21 to 24, 31 to 34, and 41 to 44, thereby matching the exposure time points of the each camera 21 to 24, 31 to 34, and 41 to 44 with the corresponding information displayed on the display screen 50, compress the time difference between the two, and improve the real-time display of multi-camera fusion images.

Those skilled in the art can understand that the above communication subsystem is only a non-limiting embodiment provided by the disclosure, aiming to clearly demonstrate the main concept of the disclosure and provide a specific solution for public implementation, rather than limiting the scope of protection of the disclosure.

Optionally, in other embodiments, the frame synchronization controller 10 can further be configured with a deep subsystem. The deep subsystem communicates with deep sensors such as direct time of flight (dTOF) sensors, indirect time of flight (iTOF) sensors, structured light sensors, monochrome imaging sensors, and/or color imaging sensors to obtain the frame synchronization signal FSync_Master from these depth sensors and/or transmit the synchronization drive signal FSync_Slave to these deep sensors to control them to synchronously collect deep information of the captured objects with the plurality of cameras 21 to 24, 31 to 34, 41 to 44 for use in mobile phones, security systems, drones, autonomous vehicles, AR/VR/MR, robots and other multi-camera devices can more accurately restore the three-dimensional images of the captured objects.

Optionally, in other embodiments, the frame synchronization controller 10 can further be configured with an ambient photon subsystem. The ambient photon subsystem is connected to one or more ambient light sensors for communication, and is used to obtain the frame synchronization signal FSync_Master from the ambient light sensor, and/or transmit the synchronization driving signal FSync_Slave to the ambient light sensor to control the ambient light sensor to synchronously collect ambient light information such as brightness and color temperature near a shooting object with the plurality of cameras 21 to 24, 31 to 34, 41 to 44, for use in mobile phones, security systems, drones, autonomous vehicles, AR/VR/MR, robots and other multi-camera devices can more accurately reproduce the ambient light effect near the shooting subject being photographed.

Although the above methods are illustrated and described as a series of actions in order to simplify the explanation, it should be understood and appreciated that these methods are not limited by the order of actions, because according to one or more embodiments, some actions can occur in different order and/or concurrently with other actions from the illustrations and descriptions herein or not illustrated and described herein, but can be understood by those skilled in the art.

The previous description is provided to enable any person skilled in the art to practice the various aspects described in this article. However, it should be understood that the scope of protection of the present invention should be based on the appended claims, and should not be limited to the specific structures and components of the embodiments described above. Those skilled in the art can make various changes and modifications to the embodiments within the spirit and scope of the present invention, and these changes and modifications are also within the scope of protection of the present invention.

What is claimed is:

1. An electronic device, comprising:
one or more processors; and
memory coupled to the one or more processors, the memory storing one or more programs configured for execution by the one or more processors, the one or more programs including instructions for:
obtaining a frame synchronization signal associated with a plurality of cameras, wherein the plurality of cameras have a plurality of shooting parameters, and the plurality of shooting parameters include at least one of a frame rate, a polarity, a pulse width, and a phase;
separately determining a synchronization driving signal, adapted to a shooting parameter of each camera, according to the frame synchronization signal; and
transmitting each synchronization driving signal to a corresponding camera, to drive the plurality of cameras to perform synchronous shooting, according to the plurality of shooting parameters.

2. The electronic device of claim 1, wherein the plurality of cameras comprise at least one master camera, and obtaining the frame synchronization signal further comprises:
obtaining the frame synchronization signal with a first shooting parameter through the master camera, wherein the first shooting parameter comprises at least one of a first frame rate, a first polarity, a first pulse width and a first phase.

3. The electronic device of claim 2, wherein the plurality of cameras further comprise at least one slave camera, and separately determining the synchronization driving signal, adapted to the shooting parameter of each camera, according to the frame synchronization signal further comprises:
determining a second shooting parameter of the slave camera, wherein the second shooting parameter correspondingly comprises at least one of a second frame rate, a second polarity, a second pulse width and a second phase; and
modulating the frame synchronization signal according to the second shooting parameter, to generate the synchronization driving signal adapted to shooting parameters of the master camera and the slave camera.

4. The electronic device of claim 3, wherein:
the plurality of cameras are divided into a plurality of camera groups;
the plurality of cameras in each of the camera groups have same shooting parameter;
the plurality of cameras between different camera groups have different shooting parameters; and
separately determining the synchronization driving signal, adapted to the shooting parameter of each camera, according to the frame synchronization signal further comprises:
determining a shooting parameter that need to be modulated according to camera group which the master camera and the slave camera belong, wherein the master camera and the slave camera belong to same camera group or different camera groups; and
modulating the frame synchronization signal according to the shooting parameter that need to be modulated, to generate a synchronization driving signal with the second shooting parameter.

5. The electronic device of claim 1, wherein the electronic device further comprises at least one subsystem, and obtaining the frame synchronization signal further comprises:
obtaining a subsystem operating signal with a third shooting parameter through the subsystem, wherein the third shooting parameter comprises at least one of a third frame rate, a third polarity, a third pulse width and a third phase; and
determining the frame synchronization signal according to the subsystem operating signal.

6. The electronic device of claim 5, wherein the subsystem further comprises a communicator coupled to an application processor of an extended reality display device, and obtaining the frame synchronization signal further comprises:
obtaining a vertical synchronization signal with the third shooting parameter from the application processor through the communicator; and
determining the frame synchronization signal according to the vertical synchronization signal.

7. The electronic device of claim 6, wherein the application processor further generates a virtual image to be synthesized along with the vertical synchronization signal, the virtual image has a first distortion, a real image to be synthesized that is captured by the plurality of cameras has a second distortion, and determining the frame synchronization signal according to the vertical synchronization signal further comprises:
obtaining a first accumulation duration of a first accumulation data amount required for correcting the virtual image, and a second accumulation duration of a second accumulation data amount required for correcting the real image, to determine a synchronization delay; and
determining a triggering time of the frame synchronization signal, according to a triggering time of the vertical synchronization signal and the synchronization delay.

8. The electronic device of claim 7, further comprises an internal memory, wherein the one or more programs further comprise instructions for:
retrieving and caching the virtual image from the application processor at a first transmission speed; and
retrieving and caching the real image from the plurality of cameras at a second transmission speed;
wherein the first accumulation duration is determined according to a ratio of the first accumulation data amount to the first transmission speed, and the second accumulation duration is determined according to a ratio of the second accumulation data amount to the second transmission speed.

9. The electronic device of claim 8, wherein the electronic device further comprises a data processor, and the one or more programs further comprise instructions for:
in response to a trigger signal generated by the data processor at regular intervals, transmitting the virtual image of the first accumulation data amount and the real image of the second accumulation data amount, cached in the internal memory, to the data processor to perform distortion removal and image synthesis; and
transferring a synthesized image obtained from the image synthesis to an external display screen to perform image display.

10. The electronic device of claim 5, wherein the subsystem comprises a communicator coupled to an external display screen, and obtaining the frame synchronization signal further comprises:
obtaining a display channel refresh signal with the third shooting parameter from the external display screen through the communicator; and
determining the frame synchronization signal according to the display channel refresh signal.

11. The electronic device of claim 10, wherein separately determining the synchronization driving signal, adapted to the shooting parameter of each camera, according to the frame synchronization signal further comprises:
determining the synchronization driving signal, indicating frame rate and phase, to drive each of the plurality of cameras to capture images, according to the third frame rate and the third phase of the display channel refresh signal.

12. The electronic device of claim 1, wherein the electronic device is further coupled to an external display screen, and the one or more programs further comprise instructions for:
determining a synchronization driving signal adapted to a display parameter of the external display screen, according to the frame synchronization signal, wherein the display parameter comprises at least one of a refresh rate, the polarity, a duty cycle, and the phase; and
transmitting the synchronization driving signal to the external display screen, to drive the external display screen to perform synchronous displaying that is corresponding to the display parameter.

13. The electronic device of claim 1, wherein separately determining the synchronization driving signal, adapted to the shooting parameter of each camera, according to the frame synchronization signal further comprises:
obtaining at least one of system power consumption parameter and system bandwidth load parameter of the electronic device;
determining the shooting parameter of each camera, according to the at least one of system power consumption parameter and system bandwidth load parameter; and
modulating the frame synchronization signal according to the shooting parameter, to generate the synchronization driving signal adapted to the shooting parameter of each camera.

14. The electronic device of claim 13, wherein the electronic device further comprises a bus monitor coupled to an extended reality display device to obtain the system power consumption parameter thereof, and determining the shooting parameter of each camera, according to the system power consumption parameter further comprises:
in response to the system power consumption parameter reaching a preset first threshold, transmitting a frame rate reduction request to a signal generator that generates a vertical synchronization signal, to reduce a third frame rate of at least one non-real-time camera among the plurality of cameras; and
in response to the system power consumption parameter decreasing to a preset second threshold, transmitting a frame rate recovery request to the signal generator to recover the third frame rate of the at least one non-real-time camera, wherein the preset second threshold is not greater than the preset first threshold.

15. The electronic device of claim 13, wherein the electronic device further comprises a bus monitor coupled to an extended reality display device to obtain the system bandwidth load parameter thereof, and determining the shooting parameter of each camera according to the system bandwidth load parameter further comprises:
in response to the system bandwidth load parameter reaching a preset third threshold, transmitting a frame rate reduction request to a signal generator that generates a vertical synchronization signal, to reduce a third frame rate of at least one non-real-time camera among the plurality of cameras; and
in response to the system bandwidth load parameter decreasing to a preset fourth threshold, transmitting a frame rate recovery request to the signal generator to recover the third frame rate of the at least one non-real-time camera, wherein the preset fourth threshold is not greater than the preset third threshold.

16. The electronic device of claim 1, wherein the electronic device further comprises the plurality of cameras.

17. A method for controlling frame synchronization, comprising:
obtaining a frame synchronization signal associated with a plurality of cameras, wherein the plurality of cameras have a plurality of shooting parameters, and the plurality of shooting parameters include at least one of a frame rate, a polarity, a pulse width, and a phase;
separately determining a synchronization driving signal, adapted to a shooting parameter of each camera, according to the frame synchronization signal; and
transmitting each synchronization driving signal to a corresponding camera, to drive the plurality of cameras to perform synchronous shooting, according to the plurality of shooting parameters.

18. The method of claim 17, wherein the plurality of cameras comprise at least one master camera, and obtaining the frame synchronization signal further comprises:
obtaining the frame synchronization signal with a first shooting parameter through the master camera, wherein the first shooting parameter comprises at least one of a first frame rate, a first polarity, a first pulse width and a first phase.

19. A non-transitory computer-readable storage medium storing one or more programs configured for execution by one or more processors, the one or more programs comprising instructions for:
obtaining a frame synchronization signal associated with a plurality of cameras, wherein the plurality of cameras have a plurality of shooting parameters, and the plurality of shooting parameters include at least one of a frame rate, a polarity, a pulse width, and a phase;
separately determining a synchronization driving signal, adapted to a shooting parameter of each camera, according to the frame synchronization signal; and
transmitting each synchronization driving signal to a corresponding camera, to drive the plurality of cameras to perform synchronous shooting, according to the plurality of shooting parameters.

20. The non-transitory computer-readable storage medium of claim 19, wherein the one or more programs further comprise instructions for:
determining a synchronization driving signal adapted to a display parameter of an external display screen, according to the frame synchronization signal, wherein the display parameter comprises at least one of a refresh rate, the polarity, a duty cycle, and the phase; and
transmitting the synchronization driving signal to the external display screen, to drive the external display screen to perform synchronous displaying that is corresponding to the display parameter.
